(19) United States
(12) Patent Application Publication
(10) Pub. No.: US 2024/0361498 A1
(43) Pub. Date: Oct. 31, 2024

(54) FABRICATION OF DIELECTRIC LAYERS WITH VARYING REFRACTIVE INDEX FOR ANTI-REFLECTION COATINGS

(71) Applicant: Meta Platforms Technologies, LLC, Menlo Park, CA (US)

(72) Inventors: Kevin Lai Lin, Pleasanton, CA (US); Anthony Abbott, Central Point, OR (US); Jie Luo, Fremont, CA (US); Paul Murray LeFebvre, Brookings, OR (US)

(21) Appl. No.: 18/306,429

(22) Filed: Apr. 25, 2023

(51) Int. Cl. G02B 1/116; C03C 17/34; G02B 1/12; G02B 27/01

(52) U.S. Cl. CPC G02B 1/116; C03C 17/3452; C03C 17/3482; G02B 1/12; G02B 27/0172

(57) ABSTRACT

A method for coating an optical substrate with an anti-reflection multilayered stack is provided. The method includes depositing a stack of dielectric layers having alternate index of refraction over a substrate, to form an anti-reflective coating. The method also includes depositing a first layer of low refractive index material on top of the stack of dielectric layers, etching the first layer of low refractive index material with a solvent at a selected temperature, and conformally depositing a sealant material over the first layer of low refractive index material to complete the anti-reflective coating. A headset for virtual reality, augmented reality, or mixed reality applications including optical components having an anti-reflection coating fabricated per the above method is also provided.

### BACKGROUND

### Field

The present disclosure is related to anti-reflection coatings (ARCs) used in optical or ophthalmic applications. More specifically, the present disclosure is related to depositing dielectric layers with varying packing density and refractive index including etch and seal stages.

### Related Art

Typical thin-film coating techniques combine two or more alternating layers of materials having high and low index of refraction. For design purposes, it is desirable to have a wide difference in the index of refraction of two materials. To avoid higher reflectivity at wide angles of incidence (e.g., in the visible wavelength domain from about 400 nm to about 750 nm), it is desirable that the upper-most dielectric layer have a low index of refraction. However, depositing low index of refraction layers is a challenging task, especially considering compatibility with the other material layers underneath, or when a sealing layer on top is desired to reduce abrasion effects, chemical contamination, and the like.

### SUMMARY

In a first embodiment, a method for coating an optical substrate with an anti-reflection multilayered stack, includes depositing a stack of dielectric layers having alternate index of refraction over a substrate, to form an anti-reflective coating. The method also includes depositing a first layer of low refractive index material on top of the stack of dielectric layers, etching the first layer of low refractive index material with a solvent at a selected temperature, and conformally depositing a sealant material over the first layer of low refractive index material to complete the anti-reflective coating.

In a second embodiment, an optical component for use in a mixed reality headset includes a transparent substrate having a curved shape, and an anti-reflective coating deposited to cover a surface of the transparent substrate at least partially. The anti-reflective coating includes a multi-layer stack of dielectric materials having an alternating index of refraction, and a top layer of a material having a selected porosity, the top layer having a refractive index lower than a refractive index of the dielectric material in bulk.

In a third embodiment, a headset for mixed reality applications includes an eyepiece configured to provide a transmitted image to a headset user, a display configured to provide a computer-generated image to the headset user, and a lens for optically coupling the display with an eye box delimiting an area where a user's pupil is located. At least one of the eyepiece or the lens includes an anti-reflection coating. The anti-reflection coating includes a substrate, a multi-layer stack of dielectric materials having an alternating index of refraction, and a top layer of a material having a selected porosity, the top layer having a refractive index lower than a refractive index of the dielectric material in bulk.

These and other embodiments will be evident to one of ordinary skill in the art, in view of the following.

### BRIEF DESCRIPTION OF THE DRAWINGS

FIG. 1 illustrates a headset for VR/AR/MR applications with at least one lens and an eyepiece having an anti-reflection coating including for VR applications, according to some embodiments.

FIGS. 2A-2C illustrate cross-section views and a reflectivity curve for an anti-reflection dielectric stack having a dielectric layer with a reduced refractive index on top, according to some embodiments.

FIG. 3 illustrates stages in a process for fabricating a multilayer dielectric stack having a reduced refractive index at the top layer, according to some embodiments.

FIG. 4 illustrates cross-sectional views before and after reduction of a refractive index at the top layer, according to some embodiments.

FIG. 5 illustrates stages in a process for fabricating a multilayer dielectric stack having a reduced refractive index layer with a controlled thickness at the top, according to some embodiments.

FIG. 6 illustrates stages in a process for fabricating a multilayer dielectric stack having varying refractive index layers at the top, according to some embodiments.

FIG. 7 illustrates cross-sectional views of anti-reflective layers having a reduced refractive index layer at the top, according to some embodiments.

FIG. 8 is a compositional chart of the cross-section of an anti-reflective multilayer dielectric stack, according to some embodiments.

FIG. 9 is a flow chart illustrating steps in a method of forming a dielectric layer with a low index of refraction for anti-reflection coating of optical surfaces, according to some embodiments.

In the figures, elements having same or similar reference numbers are assumed to have same or similar attributes and features, unless explicitly stated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure. Embodiments in the present disclosure may include features, components, structures, and processes as disclosed herein.

This disclosure relates to thin-film anti-reflection coatings (ARCs) used in optical or ophthalmic applications, where high angle and low reflectance in the visible wavelength domain (e.g., from about 400 nm to about 750 nm) is desirable. These coatings are typically composed of dielectric layers (e.g., inorganic compounds) deposited by physical vapor deposition (PVD) techniques such as plasma-enhanced, sputtering, ion beam or electron beam enhanced deposition, or chemical vapor deposition, and the like. Multilayer dielectric stacks consistent with the present disclosure may include from a few (e.g., four −4-) to as many as thirty (30) or more layers, or even more (100+).

In fabricating ARCs, it is desirable that the first layer (e.g., the outermost layer opposite the substrate) have a low refractive index (RI). This ensures that a low reflectivity is maintained even at larger angles of incidence. With a bulk RI of about 1.38, magnesium fluoride (MgF₂) has one of the lowest RIs for dielectric solids. However, it is desirable to have a first dielectric layer with an even lower RI to provide more effective AR properties to complex optical designs (e.g., having different shapes and curvatures, and the like).

To resolve the above problem, it is desirable to have PVD techniques capable of handling low index of refraction materials, e.g., magnesium fluoride, for different substrates and geometries. Magnesium fluoride coatings should desirably be durable and pass reliability testing when deposited at relatively low temperature on plastic substrates. For example, thick magnesium fluoride layers tend to develop tensile stress that may be unsustainable beyond a certain threshold. MgF₂ films deposited on plastic using current PVD techniques typically fail reliability testing, due to porosity, hygroscopic properties, and stress. Such films can be made more reliable with careful control of PVD parameters. However, durable films with an index of 1.38 or even as low as 1.35 cannot achieve broadband low reflectance at oblique angles of incidence. Some attempts to solve this problem include AR stacks with a large number of dielectric layer count. However, this complicates the fabrication process and the likelihood of error propagation. Instead, embodiments disclosed herein provide a graded index structure designed in such a way that the effective index of the outer layer approaches that of air (n=1). Accordingly, some embodiments as disclosed herein provide mechanisms and techniques to deposit porous layers of magnesium fluoride on a dielectric stack, which further reduces the refractive index and relieves the tensile stress developed by magnesium fluoride, allowing for thicker layers to be formed. In some embodiments, a buffer silica (SiO₂) layer may be disposed between two or more, bulk or porous, magnesium fluoride layers, enlarging the thickness and grading the refractive index of the top-most layer, as desired.

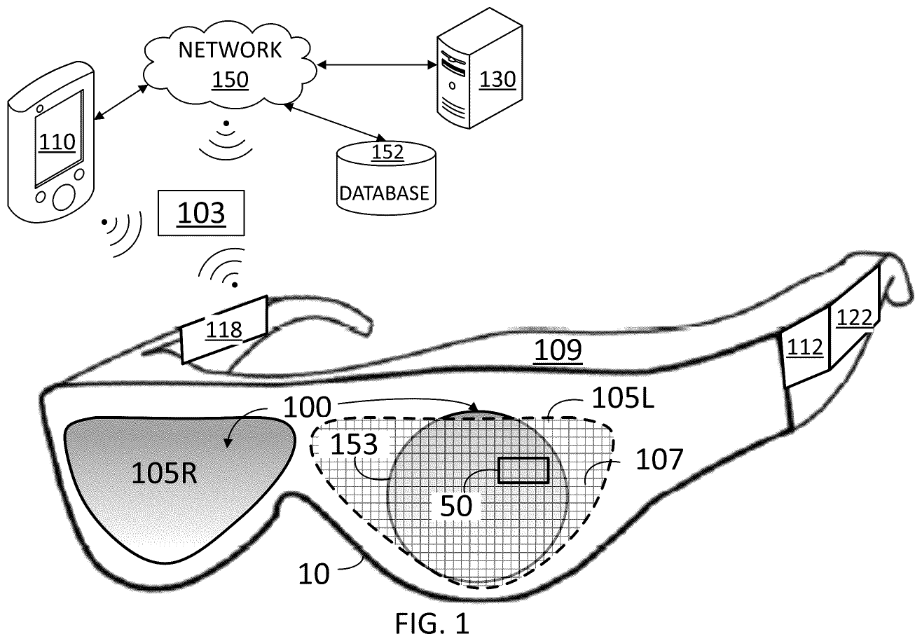

FIG. 1 illustrates a headset 10 for VR/AR/MR applications with at least one lens 153 and eyepieces 105L and 105R (hereinafter, collectively referred to as “eyepieces 105”) having an anti-reflection coating, for VR applications, according to some embodiments. Eyepieces 105 are mounted on a frame 109 and provide a transmitted image from the real world to a headset user. In some embodiments, a display 107 may also be configured to provide a computer-generated image to the headset user (e.g., for AR/VR/MR applications). A lens 153 optically couples display 107 with an eye box 50 delimiting an area where a user's pupil is located. At least one of eyepieces 105 or lens 153 includes an anti-reflection coating 100, as disclosed herein. Accordingly, anti-reflection coating 100 may include a substrate, a multi-layer stack of dielectric materials having an alternating index of refraction, and a top layer of a dielectric material having a selected porosity, the top layer having a refractive index lower than a refractive index of the dielectric material in bulk.

In some embodiments, anti-reflection coating 100 may include a conformal layer of a sealant material over the top layer to protect the anti-reflection coating. In some embodiments, anti-reflection coating 100 provides a reflectivity of less than two percent across a visible electromagnetic spectrum range. In some embodiments, anti-reflection coating 100 is formed on two opposite surfaces of eyepiece 105 or lens 153. In some embodiments, a dielectric material in the top layer is magnesium fluoride.

Headset 10 may include a processor circuit 112 and a memory circuit 122. Memory circuit 122 may store instructions which, when executed by processor circuit 112, cause headset 100 to provide the computer-generated image. In addition, headset 100 may include a communications module 118. Communications module 118 may include radio-frequency software and hardware configured to wirelessly communicate processor 112 and memory 122 with an external network 150, a remote server 130, a database 152, or a mobile device 110 handled by the user of headset 10. Headset 10, mobile device 110, server 130, and database 152 may exchange commands, instructions, and data, via a dataset 103, through network 150. Accordingly, communications module 118 may include radio antennas, transceivers, and sensors, and also digital processing circuits for signal processing according to any one of multiple wireless protocols such as Wi-Fi, Bluetooth, Near field contact (NFC), and the like. In addition, communications module 118 may also communicate with other input tools and accessories cooperating with headset 10 (e.g., handle sticks, joysticks, mouse, wireless pointers, and the like). Network 150 may include, for example, any one or more of a local area network (LAN), a wide area network (WAN), the Internet, and the like. Further, the network can include, but is not limited to, any one or more of the following network topologies, including a bus network, a star network, a ring network, a mesh network, a star-bus network, tree or hierarchical network, and the like.

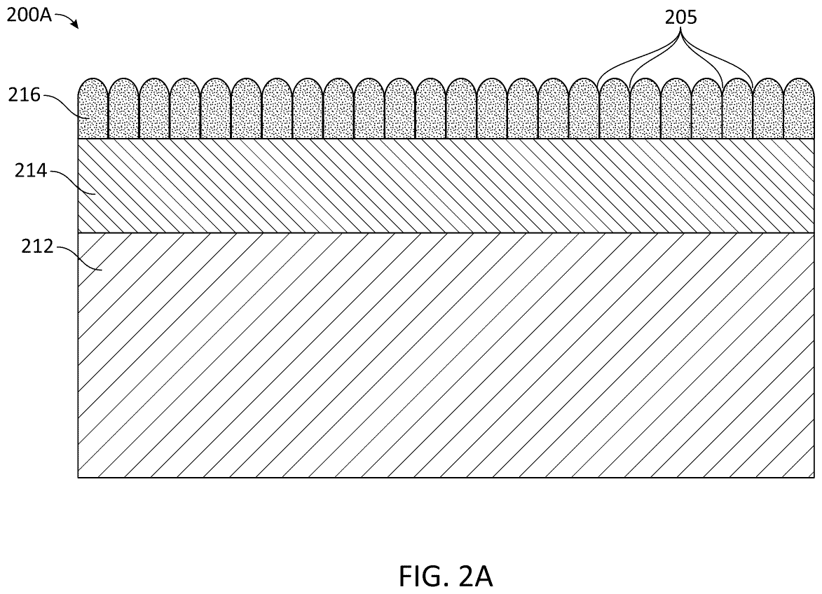

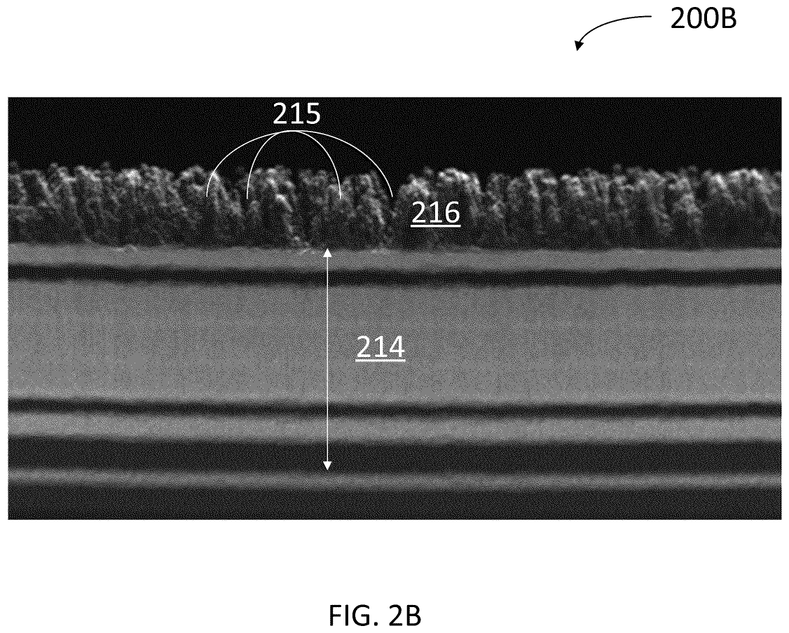

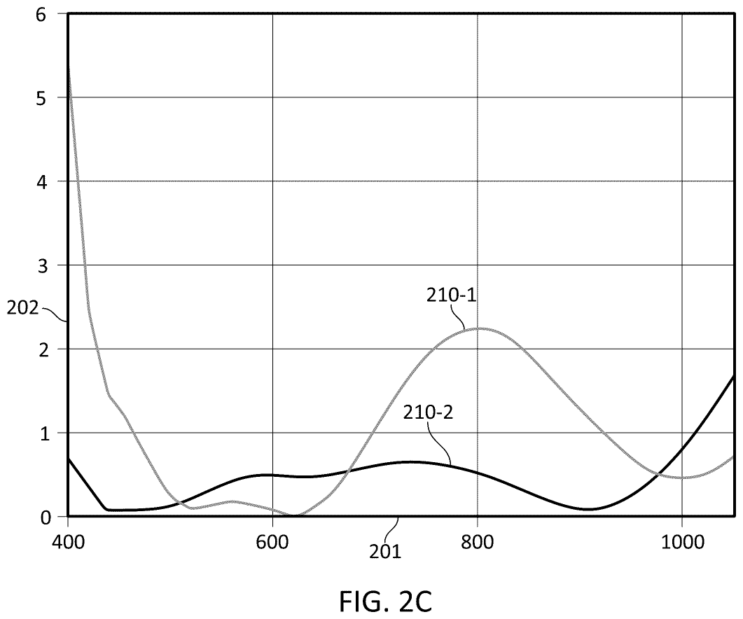

FIGS. 2A-2C illustrate cross-section views of anti-reflection coatings 200A and 200B (hereinafter, collectively referred to as “anti-reflection coatings 200”) and reflectivity curves 210-1 and 210-2 (hereinafter, collectively referred to as “reflectivity curves 210”) for an anti-reflection dielectric stack having a dielectric layer with a reduced refractive index on top, according to some embodiments. Coatings 200 are formed on a substrate 212, which can include an optical component in a VR/AR/MR headset as disclosed herein (cf. headset 10, lens 153, or eyepieces 105). In that regard, substrate 212 may include a curved shape, or a convex or concave surface, or a surface having a sharp angle. Moreover, substrate 212 may include glass, plastic, or any other transparent material used to fabricate optical components.

Anti-reflection coatings 200 include a multilayer (ARC) stack 214, and a low refractive index layer 216, on top. ARC stack 214 may include alternating layers of material having different index of refraction (e.g., high/low) adjacent to one another. Without limitation, the alternate layers of material in ARC stack 214 may include silica (SiO₂) and niobium pentoxide (Nb₂O₅), having a low/high RI, respectively (about 1.46/2.39). Additionally, the specific thickness of each of the alternating layers in ARC 214 may be selected separately, according to a desired bandwidth and angular performance of coatings 200. Layer 216 may include a suitably treated magnesium fluoride layer. In some embodiments, layer 216 includes a porous magnesium fluoride layer, such that the index of refraction of layer 216 is lower, or significantly lower than the RI of magnesium fluoride (n=1.38).

FIG. 2A illustrates a schematic representation of anti-reflection coating 200A, including pores 205. In some embodiments, the porosity of top layer 216 is higher as it gets closer to the surface of coating 200A, and is reduced towards the boundary with ARC stack 214. This creates a graded index effect of increasing RI, which is beneficial for the bandwidth and angular performance of coatings 200.

FIG. 2B is a transmission electron microscope (TEM) image of anti-reflection coating 200B, illustrating multiple pores 215 formed on layer 216. The porosity of layer 216 reduces the RI of layer 216 below the RI of the dielectric material used to form it (e.g., magnesium fluoride).

FIG. 2C illustrates reflectivity curves 210 for anti-reflection coatings 200. Reflectivity curves 200 indicate a percent reflectivity (ordinates 202) as a function of wavelength, λ (abscissae 201), when a bulk magnesium fluoride layer 210-1 is used instead of a porous magnesium fluoride layer 210-2 (e.g., top layer 216). As illustrated, a porous magnesium fluoride layer 216 reduces the reflectivity of anti-reflection coatings 200 to below 1%, across the visible spectral range (λ between about 450 nm to about 750 nm).

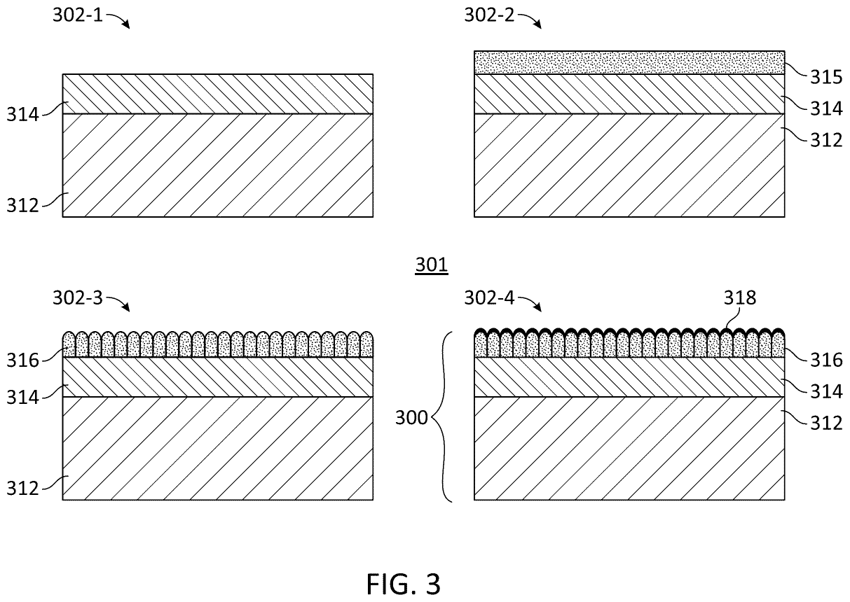

FIG. 3 illustrates stages 302-1, 302-2, 302-3, and 302-4 (hereinafter, collectively referred to as “stages 302”) in a process 301 for fabricating a multilayer dielectric stack 300 having a reduced refractive index at a top layer 316, according to some embodiments. Material deposition in process 301 may include any material deposition technique such as physical vapor deposition (PVD), chemical vapor deposition (CVP), ion-assisted vapor deposition, electron beam-assisted vapor deposition, ion bombardment, sputtering, and the like.

In stage 302-1, an ARC stack 314 is formed above a substrate layer 312. In some embodiments, ARC stack 314 includes a multi-layer stack of dielectric materials having an alternating index of refraction (e.g., high/low).

In stage 302-2, a layer 315 of a selected material is deposited adjacent to ARC stack 314. In some embodiments, the material in layer 315 is magnesium fluoride, or any other low RI dielectric material.

In stage 302-3, layer 315 from stage 302-2 is etched to form a porous layer 316 that has a reduced index of refraction, compared to layer 315. In some embodiments, stage 302-3 includes dipping the structure including layer 315 in hot de-ionized (DI) water. The temperature of the water-bath can be as high as boiling temperature (e.g., close or equal to 100° C.).

In stage 302-4, a sealant material (e.g., aluminum oxide Al₂O₃) is conformally deposited on top layer 316 to form sealant layer 318. In some embodiments, the thickness of sealant layer 318 could be a few nanometers (nm, 1 nm=10⁻⁹ m), such as five nm, or similar. Sealant layer 318 prevents chemical degradation of porous layer 316 and has little to no effect in the optical properties of multilayer dielectric stack 300.

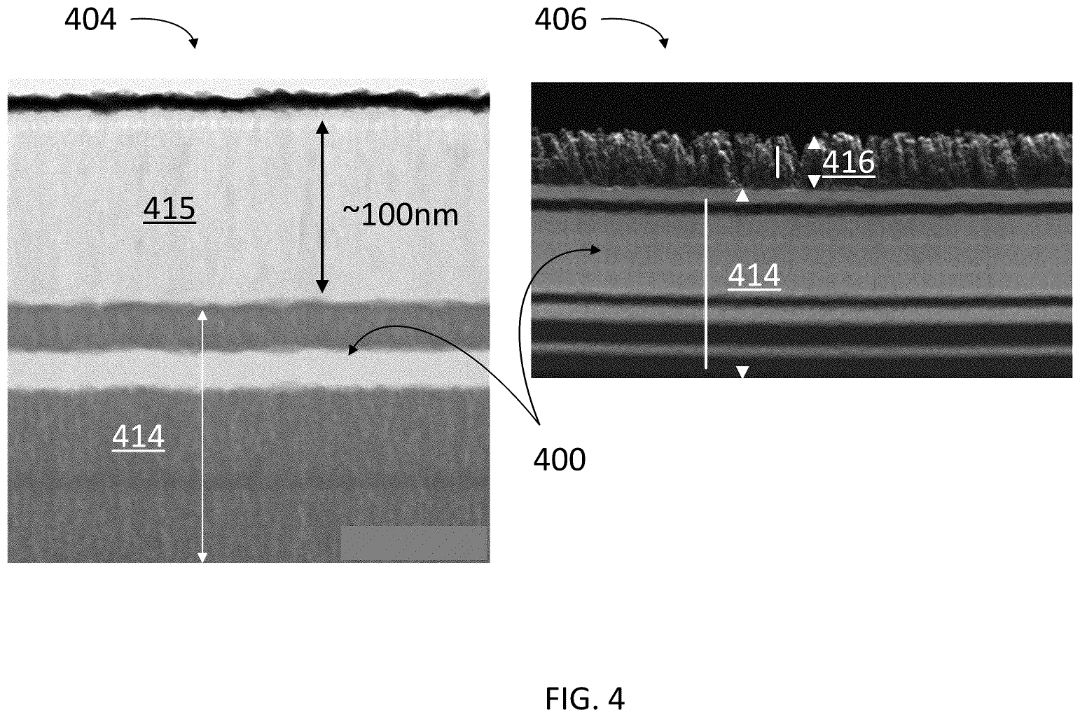

FIG. 4 illustrates cross-sectional views of a dielectric stack 400 before 404, and after 406 reduction of a refractive index at the top layer 415 on top of ARC stack 414, according to some embodiments. After subjecting top layer 415 to an etch stage (cf. stage 302-3), a porous layer 416 emerges in dielectric stack 400. A substantive thickness reduction in layer 415 is produced by the etching stage, down to porous layer 416.

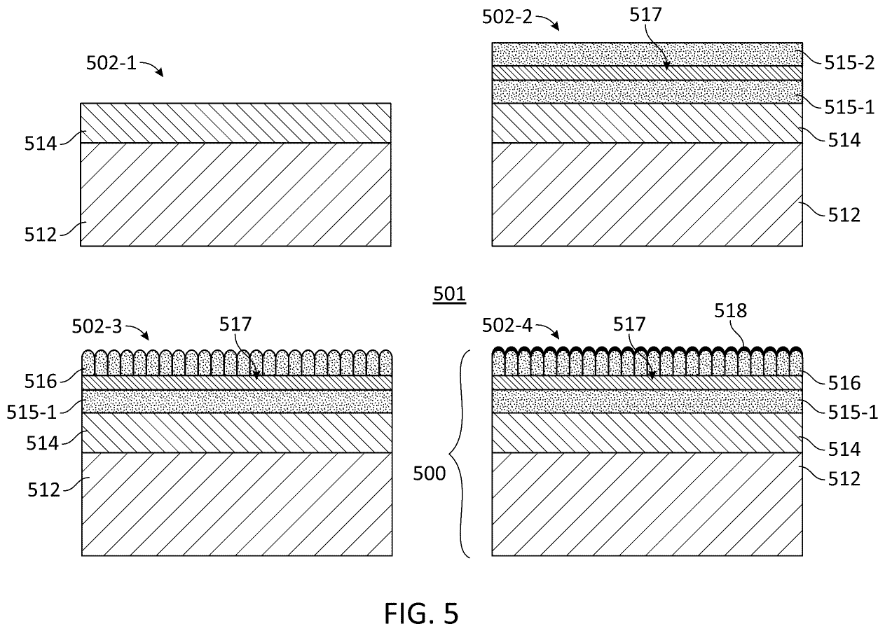

FIG. 5 illustrates stages 502-1, 502-2, 502-3, and 502-4 (hereinafter, collectively referred to as “stages 502”) in a process 501 for fabricating a multilayer dielectric stack 500 having a reduced refractive index layer 516 with a controlled thickness at the top, according to some embodiments. In some embodiments, it is desirable to control the thickness of the top dielectric layer in stack 500 for a better angular and broadband performance, and to enhance the ruggedness of stack 500.

In stage 502-1, an ARC stack 514 is formed above a substrate layer 512. In some embodiments, ARC stack 514 includes a multi-layer stack of dielectric materials having an alternating index of refraction (e.g., high/low).

In stage 502-2, an etch stop layer 517 is deposited separating two layers 515-1 and 515-2 (hereinafter, collectively referred to as “top layers 515”) of a low refractive index material (e.g., magnesium fluoride). In some embodiments, etch stop layer 517 includes silica (SiO₂). In some embodiments, etch stop layer 517 may be a few nm thick (e.g., 5-10 nm, and the like). The effect of etch stop layer 517 is to prevent layer 515-1 from being etched by DI water in stage 502-3, thereby extending the overall thickness of top layers 515. With a thickness of less than, or about, 10 nm, the optical effect of etch stop layer 517 is negligible in the visible domain.

Accordingly, etch stage 502-3 includes etching layer 515-1 with DI water at or close to a boiling point, to form porous layer 516.

Stage 502-4 may include capping porous layer 516 with a sealant layer 518 (e.g., by conformal deposition, cf. sealant layer 318). Accordingly, multilayer dielectric stack 500 has a top layer including a graded index of refraction that slowly goes down from that of the bulk material (e.g., magnesium fluoride, n=1.38) to that of the porous material in layer 516 (n<1.38) over the combined thickness of layers 515-1, 517, and 516.

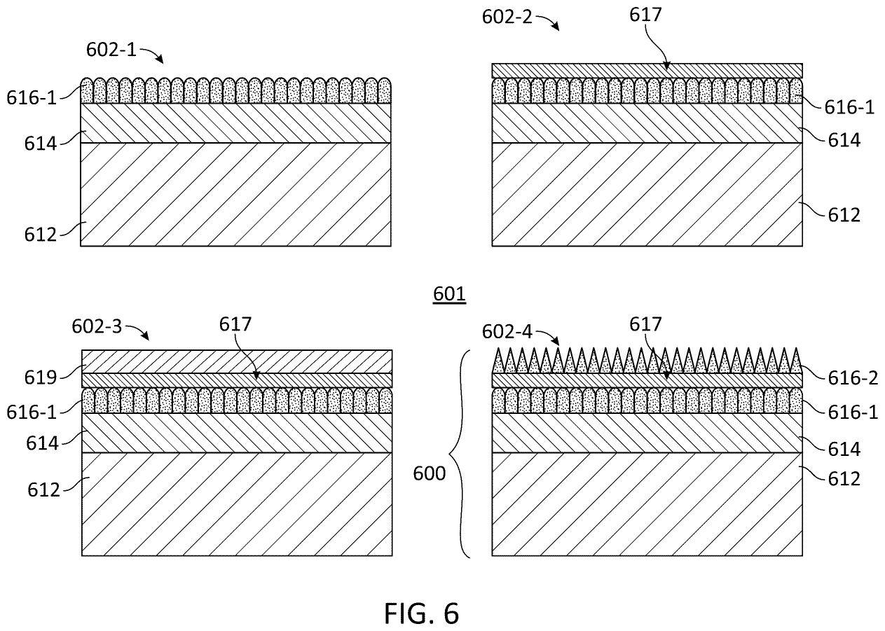

FIG. 6 illustrates stages 602-1, 602-2, 602-3, and 602-4 (hereinafter, collectively referred to as “stages 602”) in a process 601 for fabricating a multilayer dielectric stack 600 with varying refractive index layers at the top, according to some embodiments. Process 601 provides control of the packing density and thickness of top porous layers 616-1 and 612-2 (hereinafter, collectively referred to as “porous layers 616”). Having a graded index of refraction at the top layer enhances the anti-reflection properties of stack 600 by improving its angular and broadband performance.

In stage 602-1, a substrate 612, an ARC stack 614, and a first porous layer 616 (e.g., a porous layer) are disposed as shown.

In stage 602-2, an etch stop layer 617 (cf etch stop layer 517, including silica) is disposed adjacent to first porous layer 616-1.

In stage 602-3, a new layer 619 of bulk, low-index material (e.g., magnesium fluoride) is added adjacent to etch stop layer 617.

In stage 602-4, layer 619 is etched (e.g., with hot DI water, as described above) to form a second porous layer 616-2, separated from first porous layer 616-1 by etch stop layer 617. Etch stop layer 617 prevents first porous layer 616-1 from being altered during etch stage 602-3. Accordingly, and by selectively choosing different parameters for etching first porous layer 616-1, and second porous layer 616-2, a graded index of refraction may be provided by stack 600.

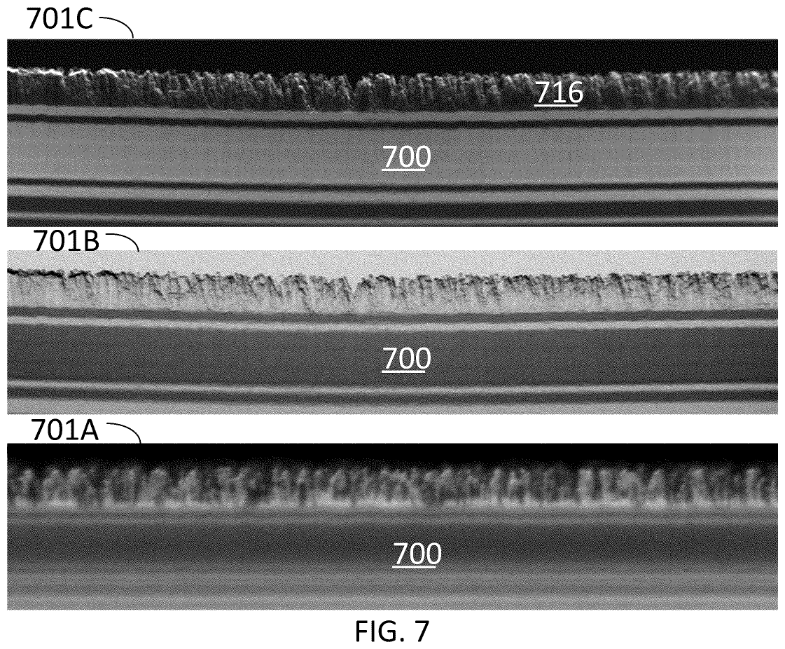

FIG. 7 illustrates cross-sectional views 701A, 701B and 701C (hereinafter, collectively referred to as “cross-sectional views 701”) of anti-reflective layer stack 700 having a reduced refractive index layer 716 at the top, according to some embodiments. Cross-sectional view 701A is a secondary-electron, scanning electron micrograph (SE-SEM), cross-sectional view 701B is a bright field, scanning transmission electron micrograph (BF-STEM), and cross-sectional view 701C is a high angle, annular dark field, transmission electron micrograph (HAADF-TEM).

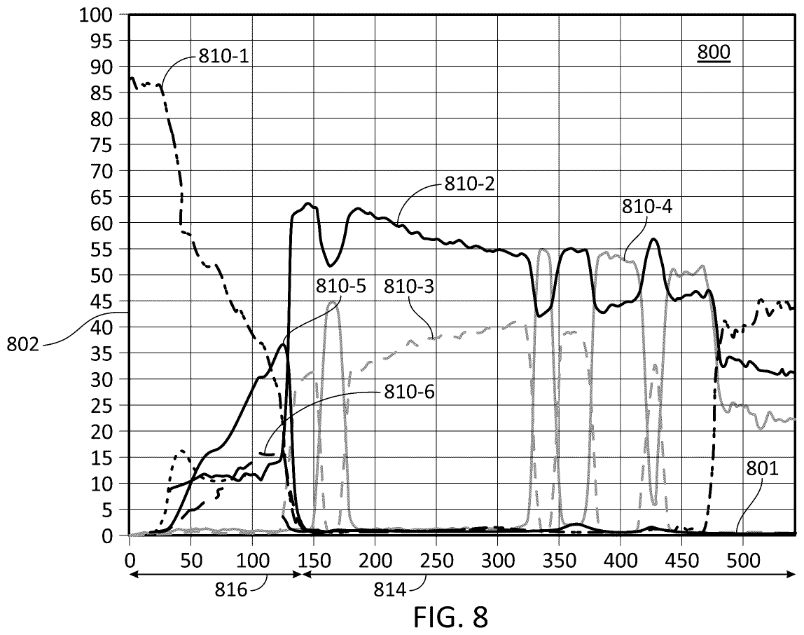

FIG. 8 is a compositional chart 800 of the cross-section of an anti-reflective multilayer dielectric stack, according to some embodiments. The abscissae 801 (X-axis) indicates depth (nm), and the ordinates 802 (Y-axis) indicate percent composition. Curves 810-1 (Carbon), 810-2 (Oxygen), 810-3 (Niobium), 810-4 (Silicon), 810-5 (Magnesium), and 810-6 (Fluor) indicate individual elements, as noted.

Curves 810-5 and 810-6 indicate a slowly increasing concentration of magnesium fluoride over about 120 nm or so from the surface of the stack. This is indicative of the porosity and therefore low RI of the top layer 816 in the stack, as desired. ARC stack 814 is indicated by the alternating composition of the different elements involved. Without limitation, ARC stack 814 is formed by alternate layers of silica (SiO₂, low RI ˜1.46) and niobium pentoxide (Nb₂O₅, high RI ˜2.39).

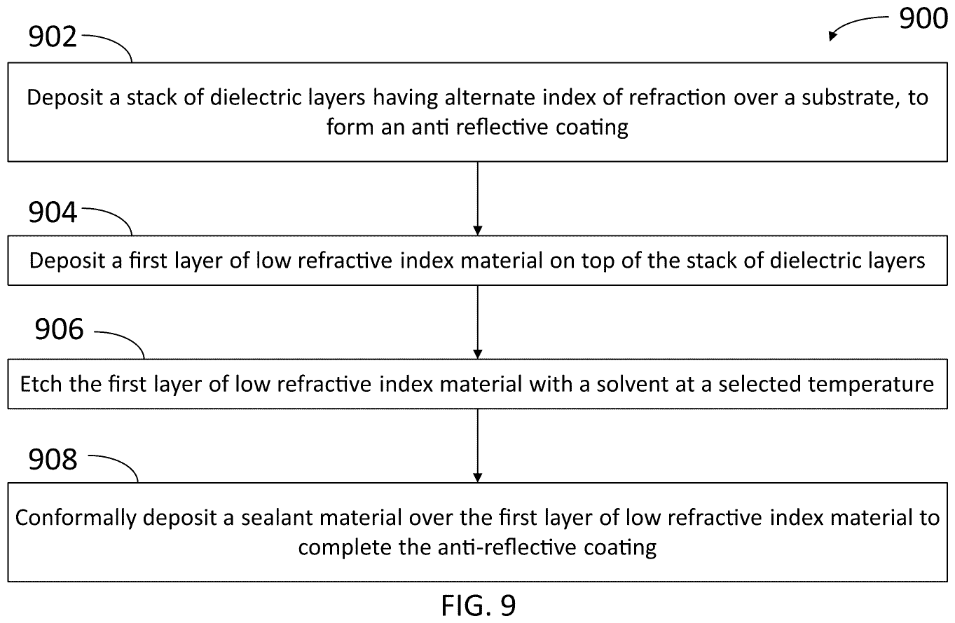

FIG. 9 is a flow chart illustrating steps in a method of forming a dielectric layer with a low index of refraction for anti-reflection coating of optical surfaces, according to some embodiments. Method 900 may be performed inside a PVD chamber as disclosed herein. The chamber may be configured to hold a substrate at a selected distance from a material source in a controlled environment having a background gas (e.g., Argon) at a selected pressure. The substrate may be held at a selected temperature. In some embodiments, at least one or more of the steps in method 900 may be partially or fully performed by a processor executing instructions stored in a memory, as disclosed herein (e.g., processor 112 and memory 122). The processor and the memory may be part of the PVD chamber, or part of a computer communicatively coupled with the PVD chamber (e.g., computer 130). Moreover, methods consistent with the present disclosure may include at least one or more of the steps in method 900 performed alone, or in any combination, simultaneously, quasi-simultaneously, or overlapping in time.

Step 902 includes depositing a stack of dielectric layers having alternate index of refraction over a substrate, to form an anti-reflective coating. In some embodiments, step 902 includes evaporatively depositing a low refractive index material on the stack of dielectric layers at a pre-selected argon pressure selected according to a selected grain size of the first layer of low refractive index material. In some embodiments, step 902 includes annealing the low refractive index material with a laser to control a grain size of the first layer of low refractive index material.

Step 904 includes depositing a first layer of low refractive index material on top of the stack of dielectric layers. In some embodiments, step 904 includes depositing an etch stop layer of silica within the first layer of low refractive index material and depositing a second layer of low refractive index material on the etch stop layer of silica.

Step 906 includes etching the first layer or the second layer of low refractive index material with a solvent at a selected temperature. In some embodiments, step 906 includes immersing the substrate with the stack of dielectric layers and the first layer of low refractive index material in the solvent, at the selected temperature. In some embodiments, step 906 includes immersing the substrate with the stack of dielectric layers and the first layer of low refractive index material in water at about a boiling point, for a selected period of time. In some embodiments, step 906 includes varying water temperature below a boiling point, with or without the presence of ultrasonic excitation. In some embodiments, step 906 includes immersing the substrate with the stack of dielectric layers and the first layer of low refractive index material in the solvent, at the selected temperature, and applying ultra-sound excitation to the solvent. In some embodiments, step 906 includes depositing an etch stop layer of silica over the first layer of low refractive index material and depositing a second layer of low refractive index material on the etch stop layer of silica. In some embodiments, step 906 includes depositing an etch stop layer of silica over the first layer of low refractive index material and depositing a second layer of low refractive index material on the etch stop layer of silica before etching the first layer of low refractive index material. In some embodiments, step 906 includes depositing an etch stop layer of silica over a porous layer of low refractive index material, depositing a second layer of low refractive index material over the etch stop layer of silica, and etching the second layer of low refractive index material with the solvent at a selected temperature to further reduce a refractive index of a top layer of the anti-reflection coating.

Step 908 includes conformally depositing a sealant material over the first layer of low refractive index material to complete the anti-reflective coating.

The subject technology is illustrated, for example, according to various aspects described below. Various examples of aspects of the subject technology are described as numbered claims. The claims are provided as examples, and do not limit the subject technology.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method, comprising:
depositing a stack of dielectric layers having alternate index of refraction over a substrate, to form an anti-reflective coating;
depositing a first layer of low refractive index material on top of the stack of dielectric layers;
etching the first layer of low refractive index material with a solvent at a selected temperature; and
conformally depositing a sealant material over the first layer of low refractive index material to complete the anti-reflective coating.

2. The method of claim 1, wherein depositing the first layer of low refractive index material comprises evaporatively depositing a low refractive index material at the top of the stack of dielectric layers at a pre-selected argon pressure selected according to a selected grain size of the first layer of low refractive index material.

3. The method of claim 1, wherein depositing the first layer of low refractive index material comprises annealing the low refractive index material with a laser to control a grain size of the first layer of low refractive index material.

4. The method of claim 1, wherein etching the first layer of low refractive index material comprises immersing the substrate with the stack of dielectric layers and the first layer of low refractive index material in the solvent, at the selected temperature.

5. The method of claim 1, wherein etching the first layer of low refractive index material comprises immersing the substrate with the stack of dielectric layers and the first layer of low refractive index material in water at about a boiling point, for a selected period of time.

6. The method of claim 1, wherein etching the first layer of low refractive index material comprises immersing the substrate with the stack of dielectric layers and the first layer of low refractive index material in the solvent, at the selected temperature, and applying ultra-sound excitation to the solvent.

7. The method of claim 1, further comprising depositing an etch stop layer of a sealant material within the first layer of low refractive index material and depositing a second layer of low refractive index material on the etch stop layer of silica.

8. The method of claim 1, further comprising depositing an etch stop layer of sealant material over the first layer of low refractive index material, and depositing a second layer of low refractive index material on the etch stop layer of silica.

9. The method of claim 1, further comprising depositing an etch stop layer of sealant material over the first layer of low refractive index material, and depositing a second layer of low refractive index material on the etch stop layer of silica before etching the first layer of low refractive index material.

10. The method of claim 1, further comprising depositing an etch stop layer of sealant material over a porous layer of low refractive index material, depositing a second layer of low refractive index material over the etch stop layer of silica, and etching the second layer of low refractive index material with the solvent at a selected temperature to further reduce a refractive index of a top layer of the anti-reflection coating.

11. An optical component for use in a mixed reality headset, comprising:
a transparent substrate having a shape conforming to an optical surface; and
an anti-reflective coating deposited to cover a surface of the transparent substrate at least partially, the anti-reflective coating further comprising:
a multi-layer stack of dielectric materials having an alternating index of refraction, and a top layer of a material having a selected porosity, the top layer having a refractive index lower than a refractive index of the dielectric material in bulk.

12. The optical component of claim 11, further comprising a conformal layer of a sealant material over the top layer to protect the anti-reflection coating.

13. The optical component of claim 11, wherein the anti-reflection coating provides a reflectivity of less than two percent across a visible electromagnetic spectrum range.

14. The optical component of claim 11, wherein the anti-reflection coating is formed on two opposite surfaces of the transparent substrate.

15. The optical component of claim 11, wherein the material in the top layer is magnesium fluoride.

16. A headset for mixed reality applications, comprising:
an eyepiece configured to provide a transmitted image to a headset user;
a display configured to provide a computer-generated image to the headset user; and
a lens for optically coupling the display with an eye box delimiting an area where a user's pupil is located, wherein
at least one of the eyepiece or the lens includes an anti-reflection coating, the anti-reflection coating comprising:
a substrate,
a multi-layer stack of dielectric materials having an alternating index of refraction, and a top layer of a material having a selected porosity, the top layer having a refractive index lower than a refractive index of the dielectric material in bulk.

17. The headset of claim 16, further comprising a conformal layer of a sealant material over the top layer to protect the anti-reflection coating.

18. The headset of claim 16, wherein the anti-reflection coating provides a reflectivity of less than two percent across a visible electromagnetic spectrum range.

19. The headset of claim 16, wherein the anti-reflection coating is formed on two opposite surfaces of the eyepiece or the lens.

20. The headset of claim 16, wherein the material in the top layer is magnesium fluoride.
